(19) United States
(12) Patent Application Publication
(10) Pub. No.: US 2006/0126450 A1
(43) Pub. Date: Jun. 15, 2006

(54) Information processing device and information processing method

(76) Inventor: Shigeto Oeda, Fujisawa (JP)

Correspondence Address: MCDERMOTT WILL & EMERY LLP, 600 13TH STREET, N.W., WASHINGTON, DC, 20005-3096, US

(21) Appl. No.: 11/203,411

(22) Filed: Aug. 15, 2005

(30) Foreign Application Priority Data
Dec. 13, 2004 (JP) 2004-359315

(51) Int. Cl. G11B 21/08

(52) U.S. Cl. 369/30.01

(57) ABSTRACT

The present invention concerns an information processing device which checks whether the content related information retrieved by the content reproducing device is associated with the content pieces recorded in the content reproducing device and which changes the functional operation and selection operation on the screen according to the check result. More specifically, the information processing device comprises: a content related information retrieve unit to retrieve the content related information such as content evaluation results into the content reproducing device; a content management unit to manage content management information such as information about content pieces recorded or received by the content reproducing device and about licenses for the content pieces; and a content control unit to determine a method of processing the content related information retrieved by the content related information retrieve unit according to the content management information held by the content management unit.

### INCORPORATION BY REFERENCE

The present application claims priority from Japanese application JP 2004-359315 filed on Dec. 13, 2004, the content of which is hereby incorporated by reference into this application.

### BACKGROUND OF THE INVENTION

The present invention relates to an information processing device to process information and more particularly to an information processing device to reproduce received or recorded content of information.

A system has been put to practical use, in which a device for playing digital content such as broadcast programs (content reproducing device) and a server are connected via network and in which the server connected to the network distributes content related information for use in the content reproducing device.

JP-A-2004-62812 discloses a system which supplies information on content held in a content reproducing device to a server and then retrieves content related information, information related to the content held in the content reproducing device, from the server.

### SUMMARY OF THE INVENTION

As to the use of content related information by the content reproducing device, the above conventional system, however, does not give any consideration to distinguishing between content held in the selected content reproducing device and content not held in that device, nor does it consider reflecting the check result on functions made available to the user and on an operation screen. The conventional system therefore could not satisfy a required level of usability.

Further, the system disclosed in JP-A-2004-62812 makes no provision for selecting information associated with particular content from among the retrieved content related information. Nor does it provide any means for the content reproducing device to check the content related information delivered from the server to distinguish between the content held in the content reproducing device and the content not held in the device and to reflect the check result on the functions made available to the user and the operation screen. Thus, the conventional system could not meet a required level of usability.

Further, the system disclosed in JP-A-2004-62812 makes it a precondition to provide information on the content held in the content reproducing device to the server, allowing the server side to know the kind of data held personally by the user. This means that a privacy issue fails to be addressed to a satisfactory level in this system. Another problem is an increased server load as user information is provided to the server.

These problems may essentially be attributed to the fact that the system can only realize uniform functional operations and on-screen operations regardless of whether the content related information retrieved by an information processing device such as content reproducing device concerns the content held in the content reproducing device.

To solve the above problem, the system needs to comprise, for example, a storage unit to store content, a receiving unit to receive information on the content, a content related information retrieving unit to pick up information on the content stored in the storage unit from among the content related information received by the receiving unit, and a control unit to output the content related information picked up by the content related information retrieving unit.

With this invention, the usability of the information processing device such as content reproducing device can be improved.

Other objects, features and advantages of the invention will become apparent from the following description of the embodiments of the invention taken in conjunction with the accompanying drawings.

### BRIEF DESCRIPTION OF THE DRAWINGS

FIG. 1 illustrates a configuration of a content reproducing device in a first embodiment of this invention.

FIG. 2 illustrates a structure of content management information in the first embodiment.

FIG. 3 illustrates a structure of content related information in the first embodiment.

FIG. 4 is a flow chart showing processing performed by a content control unit in the first embodiment.

FIG. 5 illustrates a structure of content selection information in the first embodiment.

FIG. 6 illustrates a structure of content selection information in a second embodiment.

FIG. 7 is a flow chart showing processing performed by a content control unit in a third embodiment.

FIG. 8 illustrates a structure of content selection information in the third embodiment.

FIG. 9 is a flow chart showing processing performed by a content control unit of a fourth embodiment.

FIG. 10 illustrates a structure of content selection information in the fourth embodiment.

FIG. 11 illustrates a configuration of a content reproducing device in a fifth embodiment.

FIG. 12 illustrates a structure of content related information in the fifth embodiment.

### DETAILED DESCRIPTION OF THE EMBODIMENTS

Now, the present invention will be described in a variety of embodiments.

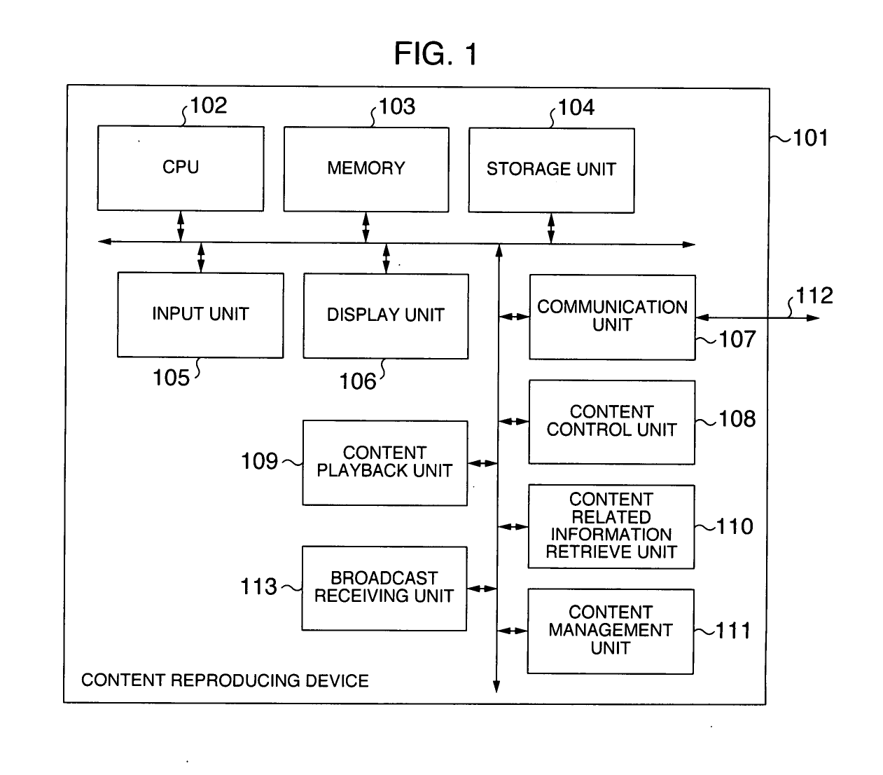

The first embodiment of this invention will be described by referring to FIG. 1 through FIG. 5. In the following description, like reference numbers and symbols refer to identical components.

FIG. 1 shows a configuration of an information processing device in this embodiment. This embodiment describes a content reproducing device 101 as an example of the information processing device. In the following embodiments, the word “content” means a content of information including image and voice data, such as, videos, still images, texts, audios, broadcast programs or movies, and CG (computer graphics).

In FIG. 1 a CPU 102 controls the entire device. A memory 103 such as ROM and RAM stores information such as program and data that CPU processes. A storage unit 104 such as hard disks can store content and an input unit 105 refers to a remote or the like that accepts inputs from the user. A display unit 106 controls screen information such as videos, still images and selection screen and displays such screen information on a display not shown such as liquid crystal display. A communication unit 107 is an Ethernet controller or protocol stack which controls data communication with other devices via network.

A content control unit 108 controls functions for content playing, recording, deleting and selection. A content playback unit 109 plays the content retrieved from the communication unit 107, the storage unit 104 and a broadcast receiving unit 113. A content related information retrieve unit 110 retrieves content related information through the broadcast receiving unit 113, communication unit 107 and the input unit 105. A content management unit 111 manages content which the local reproducing device holds or those it has the right to use. A communication path 112 allows the communication unit 107 to communicate with other content reproducing devices or content server. A broadcast receiving unit 113 obtains content from broadcast wave. Here, the content related information means information about at least one piece of content, such as content evaluation information that supplements the content, background information about the content, information about a creation of the content, and supplementary information associated with the content.

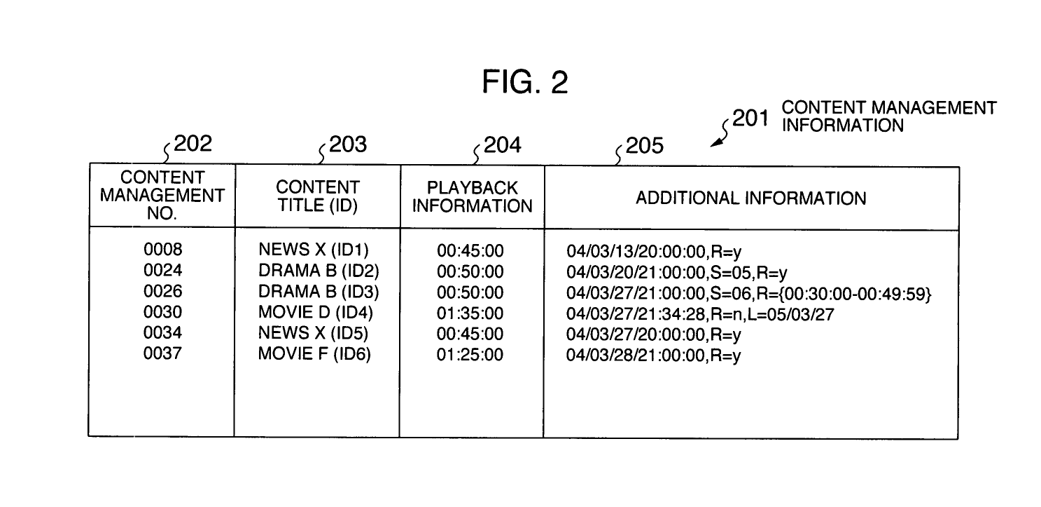

FIG. 2 shows a structure of the content management information managed by the content reproducing device. In a content management information table of FIG. 2, 202 denotes a content management number representing a reference to a recorded location of a piece of content on the storage unit; 203 denotes a content title and ID information; 204 denotes playback information indicating a time required to play the piece of content; and 205 denotes additional information, such as date and time when the content was retrieved and information as to whether it was recorded or not. The content management information is information that includes at least one of the content management number, title, ID, playback information, retrieval date and time and additional information.

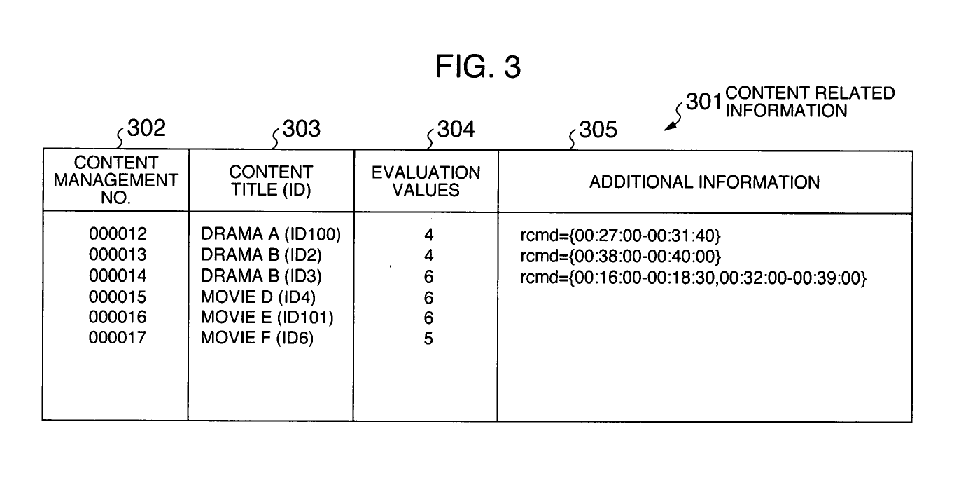

FIG. 3 shows a structure of the content related information retrieved by the content reproducing device. In the content related information of FIG. 3, 302 denotes a management number used to manage the content related information; 303 denotes a title and ID of the content; 304 denotes evaluation information about the content, an example of the related information; 305 denotes information about recommended scene, another example of the related information. The recommended scene information concerns at least one part of content which is important.

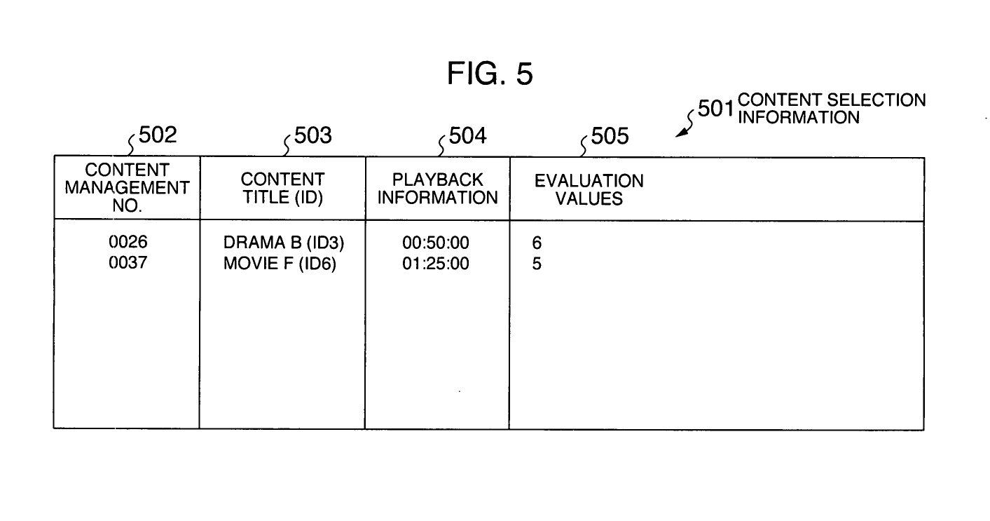

FIG. 5 shows an example screen for function operation or input operation in this embodiment. This displayed screen is created by the content control unit 108 based on the content related information.

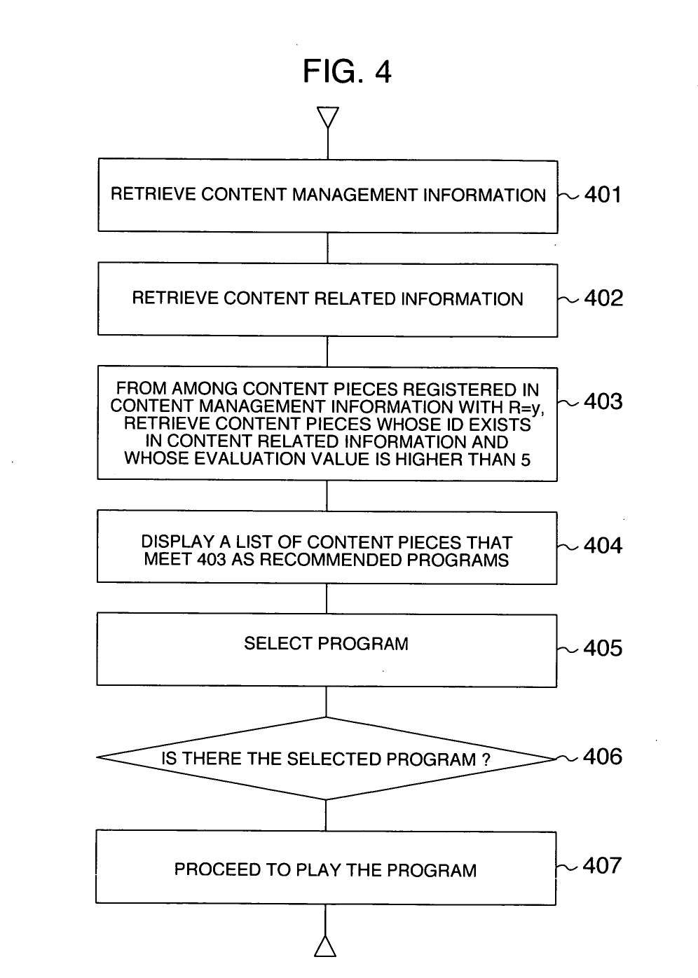

The content selection information shown in FIG. 5, one example of the information displayed on the content selection screen, is a result of changing the content related information 301 by following the processing of the content control unit 108 (see FIG. 4) according to the content management information 201. In FIG. 5, 502 denotes a content management number representing content management information; 503 denotes a title and ID of the content; 504 denotes playback information indicating a time required to play the content; and 505 denotes an evaluation value, the content related information. Here, the evaluation value refers to, for example, a value indicating a level of popularity of the content.

An operation of this embodiment is explained in the following. The content reproducing device 101 of FIG. 1 retrieves, records and plays the content according to the demand from the user. For example, the processing of retrieving, recording and playing the content specified by the user is executed as follows.

The content reproducing device 101 retrieves content selected by the user through the broadcast receiving unit 113 under the control of the content control unit 108 and then records it in the storage unit 104 according to the management by the content management unit 111. The recorded content, under the control of the content control unit 108, is displayed on a selection screen not shown, on which the user can make a selection. The content chosen by the user is retrieved from the storage unit 104 by the content control unit 108 and the content management unit 111 and is played on the display unit 106 by the content playback unit 109.

Next, this operation is explained in more detail. When the user specifies, from a list of viewable content retrieved by the broadcast receiving unit 113, a retrieval of content entitled “movie F”, the content control unit 108 causes the broadcast receiving unit 113 to start retrieving the specified content at the broadcast start time and the storage unit 104 to record the retrieved content under the management of the content management unit 111. Almost simultaneously with the reception and recording of the content, the content management unit 111 updates the content management information 201 by adding information about the content “movie F”. More precisely, the content management unit 111 records as content management information such information as content management number for uniquely identifying the location on the storage unit where the content is recorded, a content title and ID uniquely identifying the content, and content playback time. Further, information regarding the recording start time and about whether or not the content exists on the storage unit 104 is added to the content management information table as additional information.

In the example case of the additional information 205 in FIG. 2, information including (1) recording date and time and the presence or absence of recorded content in the local device (R=y/n or recorded scene {recording start time−recording end time}, (2) series number of the same program (S=nn), and (3) term of validity of license for the content is recorded as additional information.

The content control unit 108 adds the recorded content “movie F” to a content list information not shown, creates a selection screen and displays it on the display unit 106. Further, the content control unit 108 provides a function that allows the user to select a desired content, including the content “movie F”, using the input unit 105. If the user selects a playing of the content “movie F”, the content control unit 108 plays the content “movie F” through the content playback unit 109. With the above series of steps, the content reproducing device can receive and record broadcast content and, according to the instruction from the user, play the selected content. In such a content reproducing device, the content related information retrieve unit 110 in this embodiment retrieves content related information through the communication unit 107.

The following explanation concerns the content related information shown in FIG. 3. The content related information includes ID 304 capable of uniquely identifying content and information about the content. In the case of FIG. 3, the content related information includes evaluation information for each piece of content 304. Also included in the content related information are a management number 302 used for management by a person who provided the content related information, a content title 303 and content additional information 305. In FIG. 3, as the additional information 305, recommended scene information is offered for each piece of content in the form of recommended scene start time and end time (rcmd={start time−end time}). The content related information is supplied from a server connected to this device through the communication unit 107 and which has the content related information sought.

Now, referring to the flow chart of FIG. 4, how the content control unit 108 in this embodiment processes the content related information will be explained. Here, the operation of the content control unit that will be explained in the following concerns an example case where the retrieved content related information is applied to creating playable content selection information, a list of playable content from which the user selects a desired piece of content to be played, and where the playable content selection function is used to display the list on the selection screen. In this example, the content control unit retrieves content (1) whose evaluation value as the content related information is higher than a particular value and (2) which is recorded in the local content reproducing device, and then identifies and displays the retrieved content as recommended content in the playable content selection step.

In step 401 of FIG. 4, the content control unit retrieves content management information shown in FIG. 2 from the content management unit 111. In step 402, the content control unit retrieves content related information shown in FIG. 3 from the content related information retrieve unit 110. Step 403 picks up those pieces of content which, according to the content management information, are stored in the local content reproducing device, whose IDs registered in the content management information are also included in the content related information, and whose evaluation values are higher than a preset value (in this example, 5). The result of step 403 is shown in FIG. 5.

FIG. 5 shows content selection information, a list of playable pieces of content created by the content control unit 108. In the management information 502 are registered those of the content management numbers 202 in the content management information table that meet the above conditions. In content title and ID information 503 are registered content titles and IDs 203 of the content management information table. In playback information 504, playback times 204 of the content management information table are registered. In an evaluation value 505 evaluation values 304 of the content related information are registered.

In step 404 the content control unit displays a list of content retrieved at step 403 on the display unit 106. At step 405 a program selection is performed by the user using the input unit 105. If step 406 decides that the user-selected piece of content exists, the content control unit in step 407 picks up the selected piece of content as the one to be played and proceeds to play the content by cooperating with the content playback unit 109 and the content management unit 111.

With the above embodiment, an information processing device can be provided which can identify the content or change the operation, according to whether the content reproducing device is holding at least a part of the functions or at least a part of the selection screen of the content reproducing device, using content related information, or not.

Further, with the above embodiment, in playing a piece of content stored in the local content reproducing device, the user can select a desired piece of content to be played according to a content evaluation value in the content related information retrieved from other servers and content reproducing devices on the network, thus improving the usability of the device.

Further, in a content server capable of distributing content to content reproducing devices capable of holding large numbers of content pieces, since an increase in the number of recordable content pieces tends to make the management of the content held in the content reproducing devices cumbersome, it is very effective in improving the usability to provide functions according to the presence or absence of content in the local device and to provide the selection screen of content related information according to the presence or absence of content in the local device.

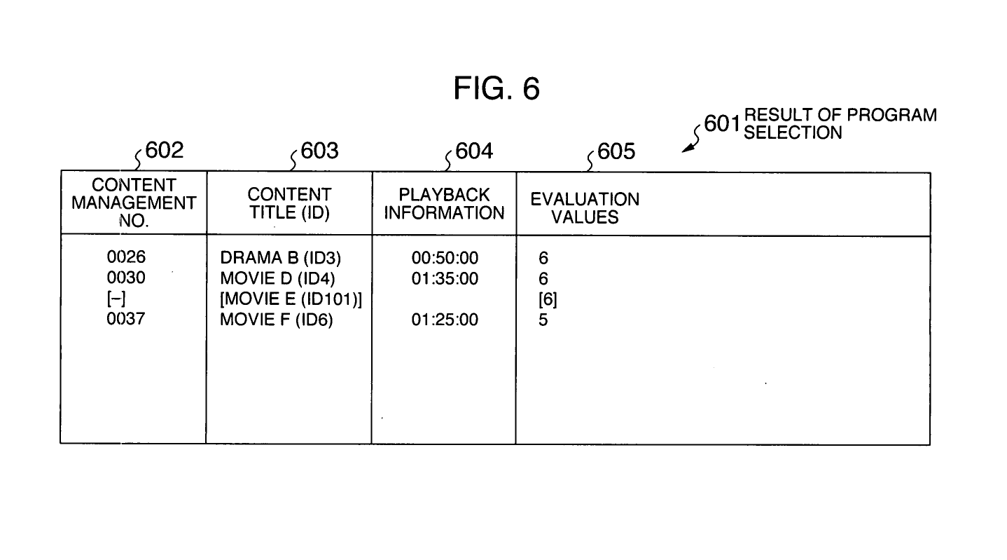

Next, a second embodiment will be explained by referring to FIG. 6. This embodiment concerns a case where the content control unit 108 also puts in the list of content in a distinguishable way recommended programs of those pieces of content not registered with the content management information table so that they also can be used on the selection screen.

The content control unit 108 performs operations similar to those shown in FIG. 4. The only difference is that this embodiment has processing, instead of step 403, to identify and register as the content selection information even those pieces of content that are classified in the content management information table of FIG. 2 as not being recorded in the local content reproducing device.

An example operation of the content control unit 108 is shown in FIG. 6. As for the content titles “movie D” and “movie E”, their evaluation values in the content related information are higher than the specified level (5) and thus meet the requirement of the decision to be made by the content control unit 108. But since these pieces of content are not recorded in the local content reproducing device, they are not included in the list of content in the preceding embodiment of FIG. 4. In this embodiment, however, the content control unit 108 puts these pieces of content in the list of content after determining if they are recorded in the local content reproducing device.

In this embodiment, the configurations of the content reproducing device, the content management information table, and the content related information are similar to those of FIG. 1, FIG. 2 and FIG. 3. The processing performed by the content control unit 108 in this embodiment is also similar to that of FIG. 4, except for step 403.

As described above, this embodiment makes available to the content control unit not only the pieces of content that are recorded in the local content reproducing device and registered in the content management information but also those pieces of content not recorded in the local device, thus widening the functions based on the content related information which are presented to the user and also a selection range on the selection screen, which in turn improves the usability.

In this embodiment, the functions and the selection screen presented to the user can also be realized in a way that classifies pieces of content not recorded in the local content reproducing device into those with a playback license and those without it. It is noted, however, that the method of identifying pieces of content not recorded in the local device is not limited to this one.

Further, although this embodiment has been shown to utilize the content related information based on the content management information, it is also possible to utilize the content management information based on the content related information. There is no particular limitation on the method of use of the content related information in the content control unit.

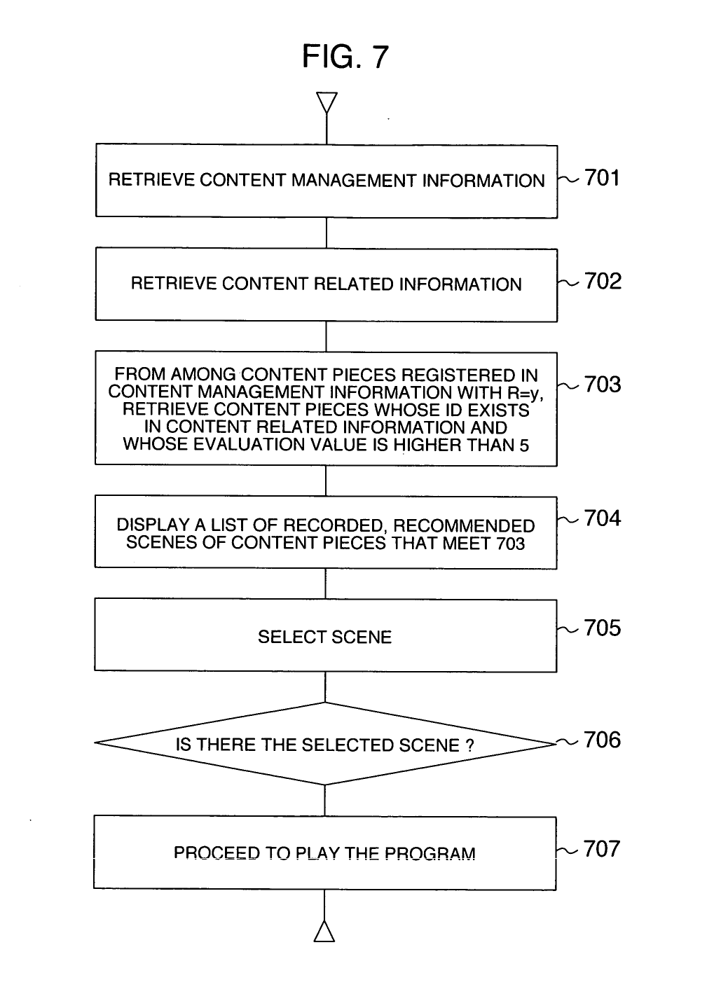

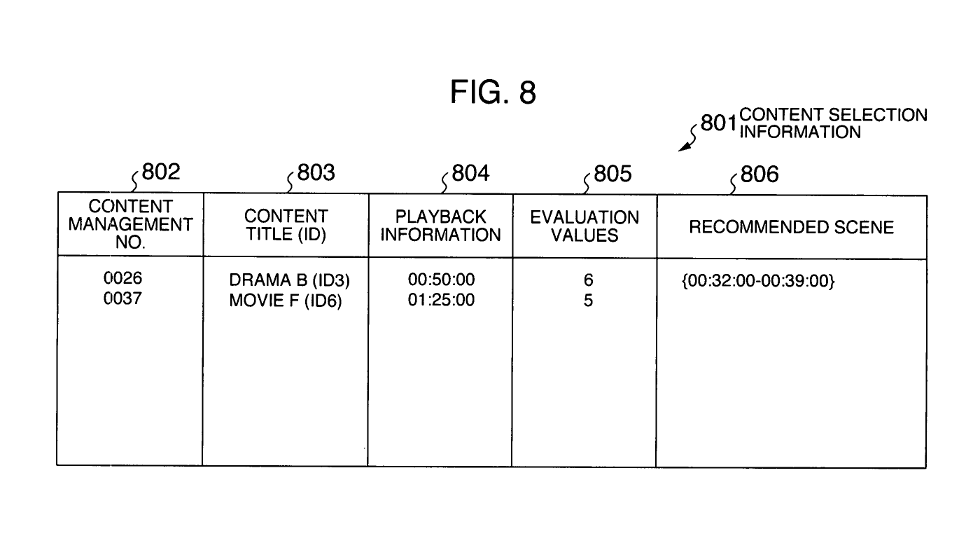

Referring to FIG. 7 and FIG. 8, a third embodiment will be described. In a content reproducing device with a similar construction to those of the preceding embodiments, this embodiment explains an operation of the content control unit which utilizes the content related information by scenes as well as by pieces of content.

FIG. 7 is a flow chart showing the operation of the content control unit 108 of this embodiment. FIG. 8 shows a structure of content selection information, a result of processing performed by the content control unit 108 of this embodiment.

The operation of this embodiment will be explained by referring to FIG. 7. At step 701, the content control unit retrieves content management information shown in FIG. 2 from the content management unit 111. At step 702, the control unit retrieves content related information shown in FIG. 3 from the content related information retrieve unit 110. At step 703, the control unit retrieves pieces of content (1) which, according to the content management information, are stored in the local content reproducing device, (2) whose content IDs registered in the content management information are included in the content related information, and (3) whose content evaluation values are higher than a predetermined value (in this embodiment, 5). Step 704 displays a list of content retrieved by step 703 on the display unit 106 as recommended programs or scenes. In step 705, the user makes a program selection using the input unit 105. Step 706 checks if there is the piece of content selected by the user. If so, step 707 picks up the specified piece of content as the one to be played and proceeds to play the selected piece in cooperation with the content playback unit 109 and the content management unit 111.

A result of operation by step 704 is shown in FIG. 8. In the management information 802 are registered those of the content management numbers 202 in the content management information table that meet the above conditions. In content title and ID information 803 are registered content titles and IDs 203 of the content management information table. In playback information 804, playback times 204 of the content management information table are registered. In an evaluation value 805, evaluation values 304 of the content related information are registered by step 704, a part of a process of the content control unit 108.

Further, in this embodiment, if there is a recommended scene (rcmd={scene start time−scene end time}) in the additional information 305 of the content related information, the content control unit refers to recorded scene information in the corresponding additional information 205 of the content management information and uses the recorded scene as a recommended scene.

For example, a title “drama B” is a piece of content registered in the content management information and which meets the requirement for the list of candidates for playing. It also has recommended scene information (rcmd={00:16:00−00:18:30, 00:32:00−00:39:00}) in the additional information 305 of the content related information of FIG. 3. Therefore, the content control unit retrieves information about the recorded scene (R={00:30:00−00:49:59}) from additional information of the same title in the content management information table of FIG. 2 and picks up that part of the recorded scene which corresponds to the recommended scene of the content related information and puts it in the recommended scene 806 of the content selection information. For the pieces of content that have no recommended scene information in the content management information, a configuration may be employed in which the recommended information can be used for each piece of content, as in the preceding embodiments.

In this embodiment, the configurations of the content reproducing device, the content management information table and the content related information are similar to those of FIG. 1, FIG. 2 and FIG. 3.

In addition to the selection and playing of recommended pieces of content in units of broadcast program, this embodiment also allows for selection and playing of recommended pieces of content by the scene when there is scene-based recommended information or content management information. This embodiment therefore can improve usability.

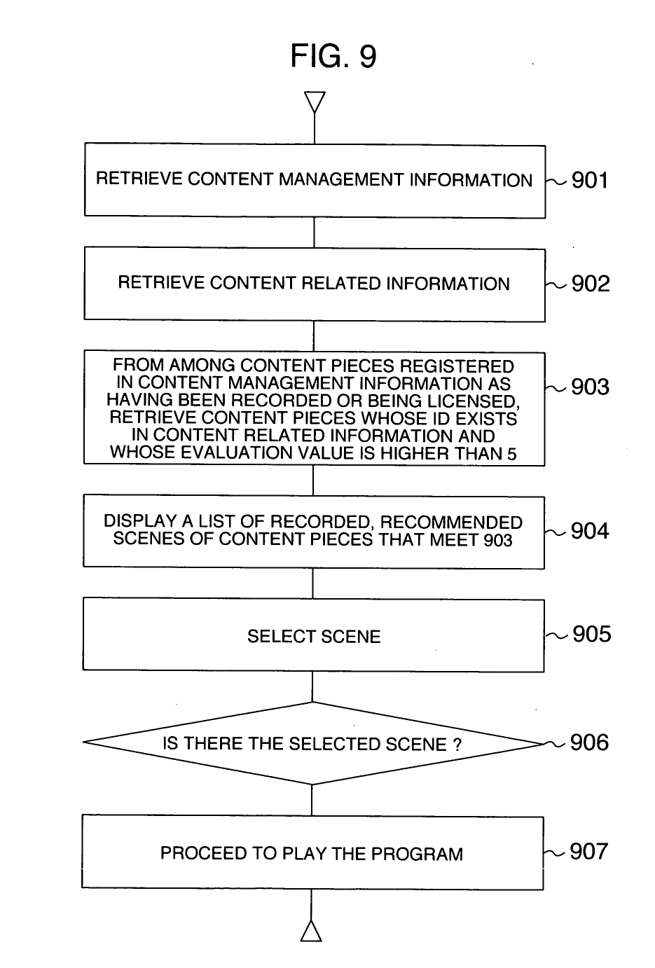

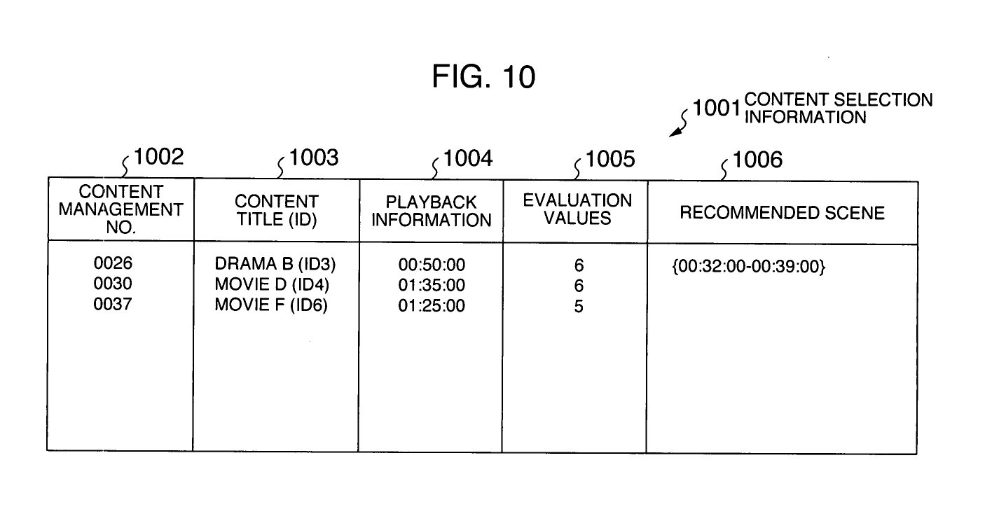

Next, a fourth embodiment will be explained by referring to FIG. 9 and FIG. 10. This embodiment concerns a case in which the content control unit has only rights to play pieces of content (playback licenses), but not the content pieces themselves, to which the content related information can be applied.

FIG. 9 is a flow chart showing a sequence of steps executed by the content control unit 108 and FIG. 10 shows an example of content selection information created by the content control unit.

Now, the operation of the content control unit in this embodiment will be explained by referring to FIG. 9. At step 901 the content control unit retrieves content management information shown in FIG. 2 from the content management unit 111. At step 902 the control unit retrieves content related information shown in FIG. 3 from the content related information retrieve unit 110. At step 903 the control unit retrieves pieces of content (1) which, according to the content management information, are stored in the local content reproducing device or for which the device has the playback license, (2) whose content IDs registered in the content management information are included in the content related information, and (3) whose content evaluation values are higher than a predetermined value (in this embodiment, 5). Step 904 displays a list of content retrieved by step 903 on the display unit 106 as recommended programs or scenes. In step 905, the user makes a scene/program selection using the input unit 105. Step 906 checks if there is the piece of content selected by the user. If so, step 907 picks up the specified piece of content as the one to be played and proceeds to play the selected piece in cooperation with the content playback unit 109 and the content management unit 111.

A result of operation by step 904 is shown in FIG. 10. The management information 1002 are registered the content management numbers 202 in the content management information table about the content that meet the above conditions by step 904, a part of a process of the content control unit 108. The content title and ID information 1003 are registered content titles and IDs 203 of the content management information table by step 904, a part of a process of the content control unit 108. In playback information 1004, playback times 204 of the content management information table are registered by step 904, a part of a process of the content control unit 108. In an evaluation value 1005 evaluation values 304 of the content related information are registered.

As for the recommended scene 1006, if there is scene information both in the content management information 201 and the content related information 301, that part of the time band in the scene information of the content management information 201 which is specified as the recommended scene (rcmd) in the additional information 305 of the content related information 301 is placed in the recommended scene 1006. For example, the recorded scene of a title “drama B (ID3)” has a time band of R={00:30:00−00:49:59} as indicated by the content management information 201 and the recommended scene has a time band of rcmd={00:16:00−00:18:30, 00:32:00−00:39:00} as indicated by the content related information 301. The time range that meets the both time information is {00:32:00−00:39:00}, which is then registered in the recommended scene 1006 of the content selection information 1001.

With this embodiment, if a piece of content of interest is not recorded in the content reproducing device, the content related information can be used according to the playback license information for that content piece. As a result, in the function of the content reproducing device to present to the user recommended pieces of content from among the playable pieces of contents based on the content related information, it is possible to include in the recommended pieces of content those content pieces for which the device has only the playback licenses but which are not recorded in the device. This in turn enhances usability. Furthermore, in addition to the recommendation in units of content pieces, a scene-based recommendation can also be made, thus realizing a program recommendation function with a finer tuning capability.

In this embodiment, the configurations of the content reproducing device, the content management information table and the content related information are similar to those of FIG. 1, FIG. 2 and FIG. 3. Further, the processing performed by the content control unit 108 in this embodiment is also similar to that of FIG. 4, except for step 403.

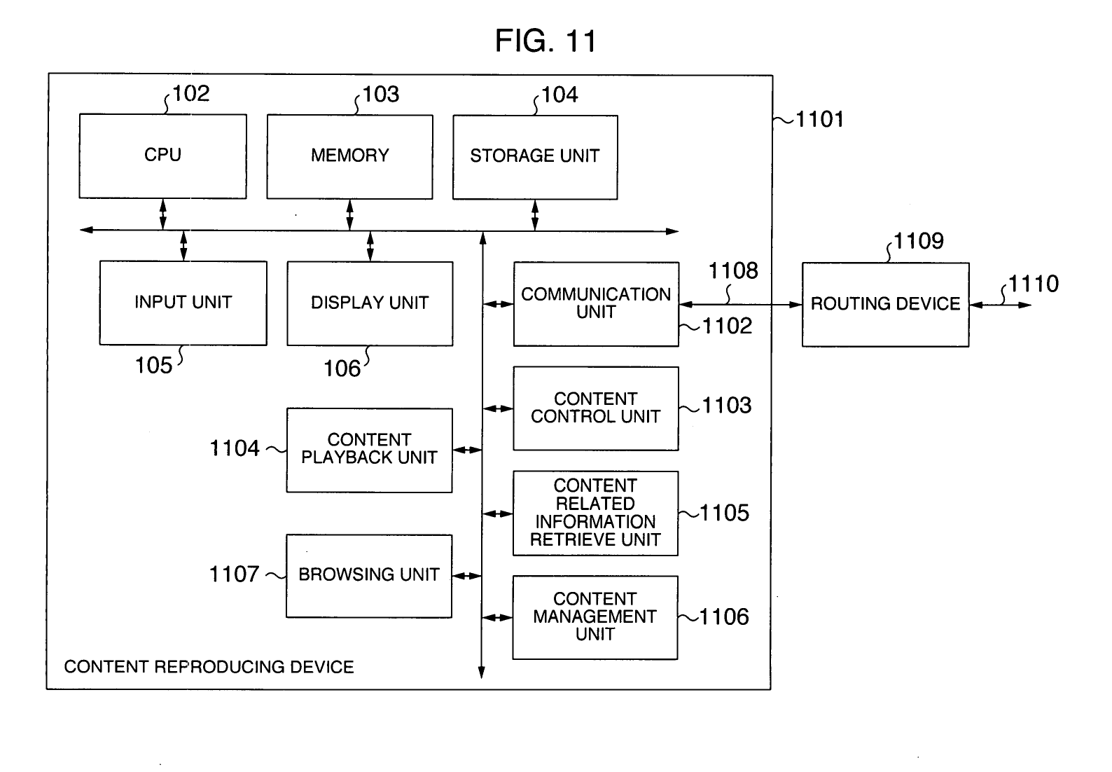

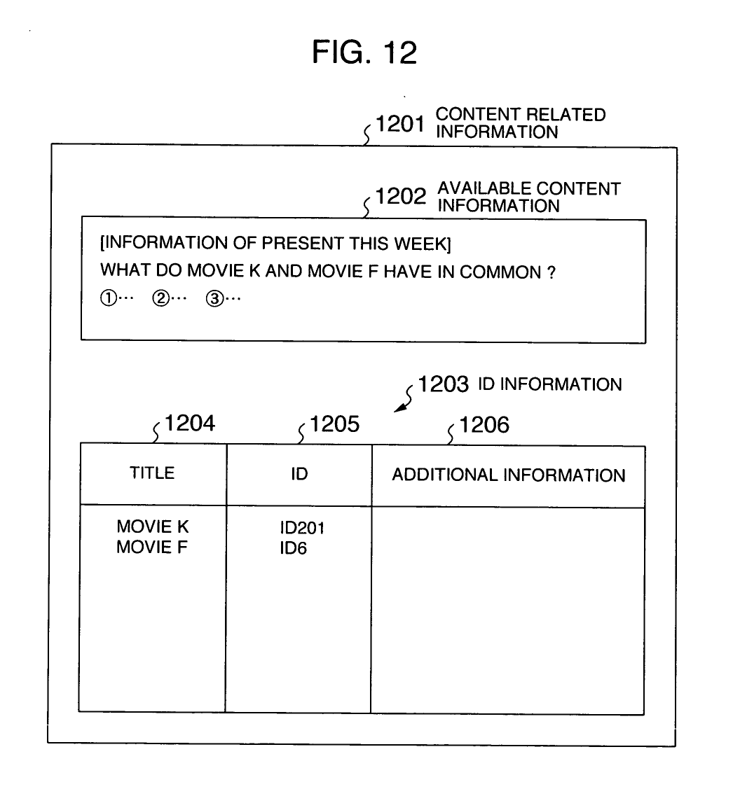

Next, a fifth embodiment will be explained by referring to FIG. 11 and FIG. 12. FIG. 11 shows a configuration of a content reproducing device of this embodiment and FIG. 12 shows a structure of content related information.

In FIG. 11, reference number 1102 denotes a communication unit that can connect to other content reproducing devices and a routing device 1109; 1103 a content control unit; 1104 a content playback unit 1104; 1105 a content related information retrieve unit; 1106 a content management unit; 1107 a browsing unit capable of rendering html files and navigation; and 1109 a routing device for connecting the network of the content reproducing device to external networks such as Internet.

In FIG. 12, reference number 1201 represents content related information of this embodiment; 1202 information about content available to the browsing unit 1107; and 1203 information about content IDs available for use by the content related information retrieve unit 1105 and the content control unit 1103. The content ID information 1203 in FIG. 12 holds information associated with the available content 1202, such as titles 1204.

In this embodiment, the content ID information comprises content titles that appear in the available content field and content IDs for the titles. In the content ID information 1203, reference number 1204 denotes a title of each piece of content, 1205 IDs that can uniquely identify pieces of content, and 1206 additional information associated with the pieces of content.

The operation of this embodiment will be explained by referring to FIG. 11. The content related information retrieve unit 1105 of FIG. 11 in cooperation with the browsing unit retrieves content related information via the routing device 1109 from an accessible information processing device connected to the external network 1110, such as Internet. In this embodiment, the information processing device is contemplated to be a http server that can provide content related information of html format which can be selected and retrieved by the browsing unit 1107 of the content reproducing device 1101.

The browsing unit 1107 retrieves the content related information specified by the user from a http server that has the target information. The content related information retrieve unit 1105 in cooperation with the browsing unit 1107 retrieves content ID information included in the content related information. The content ID information is compared with the content management information 201 by the content control unit 1103, which then changes the html file of the content related information 1201 so that the user can select a title “movie F” corresponding to the content management information 201 by using the browsing unit. Here, the changing of the html file for user selection means, for example, adding a link to the title “movie F” of the available content information so that when the “movie F” is selected, the browsing unit 1107 and the content playback unit 1104 cooperate with each other to play the selected “movie F”. The content control unit 1103 provides the changed html file of the content related information 1201 to the browsing unit 1107.

The available content information included in the content related information 1201 retrieved by the browsing unit 1107 is laid out and rendered in a specified format by the browser before being displayed on the display unit 106. The user thus can view the content management information provided by the browsing unit 1107 and select the title “movie F” through the display unit 106. When the user select “movie F”, the browsing unit 1107 in cooperation with the content playback unit 1104 plays the piece of content “movie F”.

As described above, this embodiment makes it possible to retrieve content related information from a content reproducing device, other information processing device and servers connected to external networks such as Internet, widening the range from which to retrieve the content related information.

As to the kinds of content retrieved, in addition to the content related information specially prepared for use in the content reproducing device, it is possible to use information which is provided by servers on Internet, such as general purpose http servers, mail servers and chat servers, to client applications for Internet services such as general purpose web browsers, mailers and chat clients. This embodiment therefore can expand the kinds of content related information that can be used, thereby improving usability.

In this embodiment, the configurations of the content reproducing device, the content management information table, and the content related information are similar to those of FIG. 1, FIG. 2 and FIG. 3. The processing performed by the content control unit 108 in this embodiment is also similar to that of FIG. 4, except for step 403.

While in this embodiment the content related information is contemplated to be a html file, it is not limited to this format. Further, although this embodiment is configured such that a http server on the network 1110 provides the content related information to the content reproducing device, there is no particular limitation on the configuration of the information processing device that applies the content related information. For example, other information processing devices such as mail servers and chat servers connected on the Internet may be used to retrieve the content related information. This expands the range from which the content related information can be retrieved, improving usability.

Further, while this embodiment has been described to have ID information in the html file as the content related information, the structure of the content related information is not limited to this one. For example, content related information may be written in a mail of ordinary text format that can be retrieved by the content reproducing device which then receives and uses it. This improves the degree of freedom of format for the content related information, improving the usability.

While in the preceding embodiment 1 to 5 the content control unit, the content playback unit, the content related information retrieve unit and the content management unit have been defined as independent functions in the content reproducing device, as shown in FIG. 1, a part or all of these functions may be implemented in the form of a program executed by the CPU. There is no particular limitation on the method of implementing these functions. It is therefore possible to implement these functions in hardware, software or combination of these, widening the range of configurations of the device and improving usability.

While in the preceding embodiments content has been described to be retrieved from the broadcast receiving unit, it can also be retrieved through the communication unit or input unit. There is no particular limitation on the method of content retrieval. As a result, a desired content retrieval means can be selected or a range of content retrieval means widened, improving the usability.

Further, while in the preceding embodiments the content related information is retrieved from the network via the communication unit, it can also be retrieved through the broadcast receiving unit or input unit. There is no particular limitation on the method of retrieving content related information. As a result, a desired content related information retrieval means can be chosen or a range of retrieval means widened, improving the usability.

Further, although the preceding embodiments do not give detailed definitions on the method of retrieving the content related information, it is possible to retrieve content from a particular location when demanded from the user or when a particular condition for program retrieval is met. It is also possible to send content related information through broadcasting or network when content is retrieved. There is no particular limitation on the method of retrieving content related information. This makes it possible to flexibly select or set the method and timing for retrieving content related information, thus improving the usability.

Further, although the above embodiments have been shown to apply the content related information retrieved by the content control unit to the manipulation screen for the user to select a desired piece of content for playing, the manipulation screen can also be used for other functions provided by the content reproducing device, such as content recording function and content deleting function, or to change the operation of these functions. There is no particular limitation on where and how the retrieved content related information is used when applying the retrieved content related information to the functional operations and manipulation screen according to the content. For example, on the manipulation screen in which a content deletion function displays a list of content as candidates for deletion, those of the content pieces recorded in the local content reproducing device and registered in the content management information which are given low evaluation values may be presented as candidates for deletion; or they may be automatically deleted. This improves usability of the device on the part of the user.

It should be further understood by those skilled in the art that although the foregoing description has been made on embodiments of the invention, the invention is not limited thereto and various changes and modifications may be made without departing from the spirit of the invention and the scope of the appended claims.

1. An information processing device comprising:
a storage unit to store pieces of content;
a receiving unit to receive information related to pieces of content;
a content related information retrieve unit to retrieve a content related information corresponding to the pieces of content stored in the storage unit from the information related to the pieces of content received by the receiving unit; and
a control unit to perform control according to the content related information retrieved by the content related information retrieve unit.

2. An information processing device according to claim 1, further including a content management unit to manage the pieces of content stored in the storage unit by content piece.

3. An information processing device according to claim 2, wherein the content management unit manages information about licenses for the pieces of content recorded in the storage unit or received by the receiving unit.

4. An information processing device according to claim 2, wherein the control unit controls the content related information retrieved by the content related information retrieve unit so as to display information about the available pieces of content based on content management information managed by the content management unit.

5. An information processing device according to claim 1, further comprising a content management unit capable of managing the content by scene;
wherein the content related information includes scene information representing a predetermined scene of content;
wherein the content related information retrieve unit can retrieve the content related information including the scene information;
wherein the control unit performs control to distinguish and output a method of use of the scene-based content related information retrieved by the content related information retrieve unit according to the content management information held in the content management unit.

6. An information processing device according to claim 1, wherein the content related information includes information about evaluations or recommendations of the pieces of content.

7. An information processing device according to claim 1, wherein the content related information includes advertisement information or publicity information.

8. An information processing device according to claim 1, wherein the content related information is retrieved from the Internet.

9. An information processing device according to claim 2, wherein the control unit performs control to change a method of selecting pieces of content to be moved, copied or deleted according to the content management information managed by the content management unit and the content related information retrieved by the content related information retrieve unit.

10. An information processing device comprising:
a storage unit to store video and/or voice data and management information used to manage the video and/or voice data in units of video and/or voice data;
a receiving unit to receive information about video and/or voice data;
an extraction unit to extract information about the video and/or voice data stored in the storage unit from among the information about the video and/or voice data received by the receiving unit; and
a control unit to change a method of reproducing the information about the video and/or voice data extracted by the extraction unit according to the information about the video and/or voice data identified based on management information.

11. An information processing method comprising:
a storing step to store pieces of content;
a receiving step to receive information about the pieces of content;
a content related information retrieving step to retrieve information about content pieces stored by the storing step from among the information about the content pieces received by the receiving step; and
a control step to perform control according to the information about the content pieces retrieved by the content related information retrieving step.

12. An information processing method according to claim 11, further including a content management step to manage the content pieces stored by the storing step in units of content pieces.

13. An information processing method according to claim 12, wherein the content management step manages information about licenses for the content pieces stored by the storing step or received by the receiving step.

14. An information processing method according to claim 12, wherein the control step controls the content related information retrieved by the content related information retrieving step so as to display information about available pieces of content based on the content management information managed by the content management step.
